(19) United States
(12) Patent Application Publication
(10) Pub. No.: US 2025/0383847 A1
(43) Pub. Date: Dec. 18, 2025

(54) GENERATING AN APPLICATION INTEGRATION USING A LARGE LANGUAGE MODEL

(71) Applicant: Insight Direct USA, Inc., Chandler, AZ (US)

(72) Inventor: Lavanya Lakshminarasimhan, Chandler, AZ (US)

(21) Appl. No.: 19/237,761

(22) Filed: Jun. 13, 2025

Related U.S. Application Data
(60) Provisional application No. 63/660,015, filed on Jun. 14, 2024.

(51) Int. Cl. G06F 8/35

(52) U.S. Cl. CPC G06F 8/35

(57) ABSTRACT

A method of producing an integration path for the communication of information from a first application to a second application includes formulating a mapping guide, an origin information field template, and a destination information field template dependent upon the first application, the second application, and the information that is to be communicated. The method can further include initiating the generation of a prompt for a large language model with the prompt having a system portion that includes a generic instruction and a user portion that includes specific instructions dependent upon the mapping guide, origin information field template, and destination information field template; receiving the software code that, when executed, provides for a partial integration path; and associating, with the software code, connection information that links an origin to the first application and connection information that links a destination to the second application to generate a complete integration path.

### CLAIM OF PRIORITY

This application claims the benefit to U.S. Provisional Application No. 63/660,015, filed Jun. 14, 2024, and entitled “PROGRAM/APPLICATION INTEGRATION USING A LARGE LANGUAGE MODEL,” which is incorporated by reference herein in its entirety.

### FIELD OF THE INVENTION

The disclosure relates generally to the integration of one computer software program/application with another and, more specifically, to using a large language model to generate software code (e.g., an integration path) for the transformation of information from one program/application for use by another program/application.

### BACKGROUND

The integration of two computer software programs/applications (hereinafter referred to just as “applications”) requires information from one application to be transformed into a language/format that is acceptable by the other application. The process of transforming the information is set out in protocols, which include transformation rules, that detail the steps that need to be performed to allow for the second application to accept and use information from the first application, known as an integration path. The protocols and other information regarding the applications, integration, etc. are detailed in three documents: a business requirement document, a functional specification, and a technical specification. These three documents detail the information that is to be exchanged with one another and give a roadmap to a technical team that is tasked with developing/effectuating the creation, validation, and deployment of the integration path.

The development and deployment of the integration path is a complex and time-consuming process. Creating the integration path for multiple applications having multiple different connection points/nodes, individual mapping/routes from one schema/format/language of one application to another schema/format/language of another application, and/or getting permissions/authorizations to access, send, and/or receive the information, applications, etc. is difficult for a development team tasked with creating the integration paths. Thus, it is advantageous to simplify this process across all integrations of applications to reduce time, expense, and resource requirements.

### SUMMARY

An example method of producing an integration path for the communication of information from a first application to a second application is disclosed herein that includes formulating a mapping guide, an origin information field template, and a destination information field template dependent upon the first application, the second application, and the information that is to be communicated, wherein the origin information field template and the destination information field template each include at least one sample value in each information field that is to be communicated from the first application to the second application. The method can also include digitally naming the mapping guide dependent upon the first application and the second application; continually monitoring, by an integration generation program that functions in conjunction with at least one computer processor, a first designated digital memory location for presence of digital data; and, in response to the presence of the digital data in the first designated digital memory location, evaluating the digital data to determine whether the digital data includes the mapping guide, origin information field template, and destination information field template in the digital data. The method can further include, in response to determining that the digital data includes the mapping guide, origin information field template, and destination information field template, automatically initiating the generation of a prompt for a large language model with the prompt having a system portion that includes a generic instruction and a user portion that includes specific instructions dependent upon the mapping guide, origin information field template, and destination information field template; providing the prompt that at least partially includes the mapping guide, origin information field template, and destination information field template to the large language model that requests the large language model to generate software code that, when executed, provides for a partial integration path for the communication of information from an origin to a destination; receiving the software code from the large language model; and associating, with the software code, first connection information that links the origin to the first application and second connection information that links the destination to the second application to generate a complete integration path that, when performed by at least one computer processor, allows for the communication of information from the first application to the second application.

An example system for producing an integration path for the communication of information from a first application to a second application is disclosed herein that includes a mapping guide that is digitally named dependent upon the first application and the second application, an origin information field template having at least one sample value in each information field that is to be communicated from the first application to the second application, a destination information field template having at least one sample value in each information field that is to be received by the second application from the first application, and an integration generation software program that functions in conjunction with at least one computer processor. The integration generation program can be configured to continually monitor a first designated digital memory location for presence of digital data; in response to the presence of the digital data in the first designated digital memory location, evaluate the digital data to determine whether the digital data includes the mapping guide, origin information field template, and destination information field template; in response to the determination that the digital data includes the mapping guide, origin information field template, and destination information field template, automatically initiate the generation of a prompt for a large language model with the prompt having a system portion that includes a generic instruction and a user portion that includes specific instructions dependent upon the mapping guide, origin information field template, and destination information field template; provide the prompt that at least partially includes the mapping guide, origin information field template, and destination information field template to the large language model that requests the large language model to generate software code that, when executed, provides for a partial integration path for the communication of information from an origin to a destination; and receive the software code from the large language model. The system can further include a complete integration path that, when performed by at least one computer processor, allows for the communication of information from the first application to the second application, the complete integration path having a first connection that links the first application to the origin set out in the software code, the software code that provides instructions for the communication of information from the origin to the destination, and a second connection that links the destination set out in the software code to the second application.

### BRIEF DESCRIPTION OF THE DRAWINGS

FIG. 1A is a block schematic diagram of an example integration generation system for use with a large language model to generate an integration path to allow for communication of information from a first application to a second application.

FIG. 1B is an example mapping guide electronic document for use in generating an integration path.

FIG. 1C is an example origin information field template for use in generating an integration path.

FIG. 1D is an example destination information field template for use in generating an integration path.

FIG. 2 is a method flow chart describing an example process for generating an integration path to allow for communication of information from a first application to a second application.

While the above-identified figure sets forth one or more examples of the present disclosure, other examples/embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figure may not be drawn to scale, and applications and examples of the present invention may include features and components not specifically shown in the drawings.

### DETAILED DESCRIPTION

Processes and systems are disclosed herein that generate a complete integration path using information extracted from a technical specification document (hereinafter also referred to as a “TSD”) to allow for the communication of information from a first application to a second application. The complete integration path or a portion of the integration path, called a partial integration path, can be generated by a large language model (hereinafter also referred to as an “LLM”) in response to a prompt that includes a request for the LLM to generate software code that includes the partial integration path and also includes at least a portion of information extracted from the TSD, such as a mapping guide, an origin information field template, and a destination information field template. The LLM can output software code that includes the partial integration path, which can then be added to and/or otherwise edited to include connection information to link the information fields of the first application to the partial integration path and the partial integration path to the information fields of the second application, thus providing for a complete integration path to allow for the communication of information from the first application to the second application.

The origin information field template can include multiple information fields that are able to be communicated from the first application (and not just the information fields that are to be communicated from the first application to the second application using the complete integration path) with each information field having at least one sample value, even if that specific information field is not being communicated to the second application. Similarly, the destination information field template can include multiple information fields that are to be received by the second application (and not just the information fields that are to be received from the first application by the second application using the complete integration path) with each information field having at least one sample value, even if that specific information field is not being received from the first application. These origin and destination information field templates that have sample values for all information fields are provided to the LLM and are used by the LLM to generate the software code that includes/effectuates the partial integration path. Without all information fields having sample values, the LLM may be more likely to generate the software code/partial integration path that does not function as intended and/or does not allow for the communication of information from the first application to the second application.

The disclosed systems and methods can include an integration generation software program/application configured to extract/formulate the mapping guide, origin information field template (hereinafter also referred to as “OIF template”), and/or destination information field template (hereinafter also referred to as “DIF template”) from/based upon any documents associated with the intended exchange of information from and/or between the first application and the second application. In the example disclosed herein, that document can be a technical specification document formulated and/or otherwise used during the initial integration information collection phase of the project. The integration generation software program can be configured to automatically extract/formulate the necessary documents/information in response to reception of and/or access to the technical specification document and/or other information. Additionally and/or alternatively, the integration generation software program can be configured to automatically generate the prompt and provide the necessary prompt and information to the LLM to solicit an output from the LLM (which can be the software code/partial integration path). For example, the integration generation software program can continually monitor a first designated digital memory location (e.g., storage media) for the presence of digital data. In response to the presence of the digital data in the first designated digital memory location, the integration generation software program can evaluate the digital data to determine whether the digital data includes the mapping guide, OIF template, and DIF template in the digital data. In response to determining that the digital data includes the mapping guide, OIF template, and DIF template, the integration generation software program can initiate the generation of the prompt. Thus, the presence of the digital data in the first designated digital memory location can form a trigger in the integration generation software program to initiate the generation/creation of the prompt. In this example, the first designated digital memory location can be storage media that is not directly accessible by a user/operator of the systems and/or integration generation software program.

The disclosed systems and methods provide for a great increase in time and efficiency and a reduction in costs and effort to generate a complete integration path between a first application and a second application by leveraging an LLM to generate a portion of that integration path (e.g., generate software code) dependent upon the prompt, the mapping guide, the OIF template, and/or the DIF template. The information provided to the LLM must be complete, explained, and provided in a specific organization and format to ensure that the output from the LLM is complete and accurate to avoid the need for edits/alterations thereafter, which would increase the costs and effort to generate the complete integration path. The disclosed systems and methods can reduce the amount of time, effort, and resources (e.g., cost) needed to generate the integration path greatly, for example, by 80% or more. These and other advantages of the disclosed systems and methods will be realized by reviewing the following disclosure.

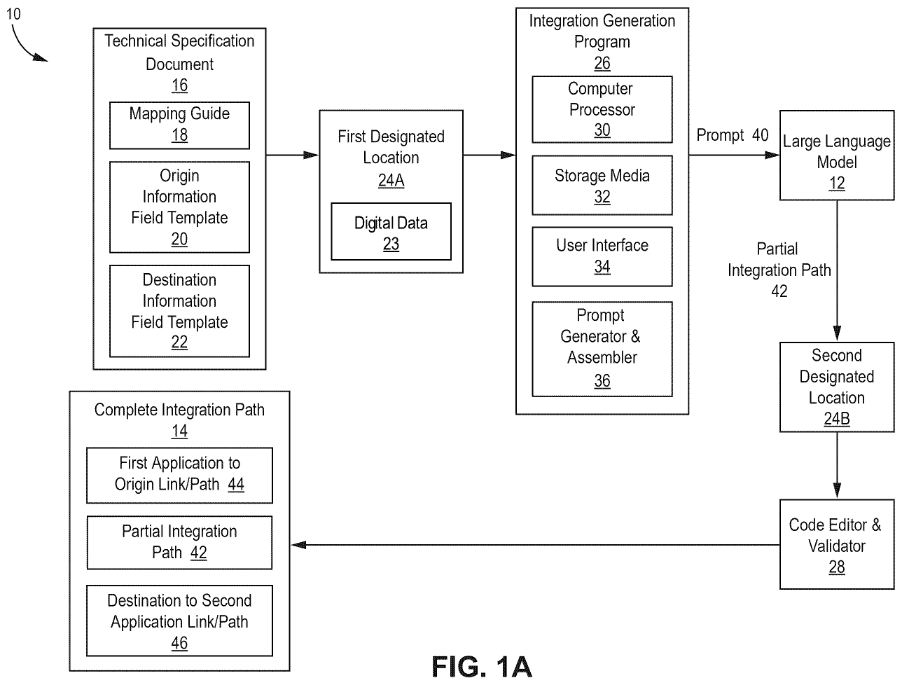

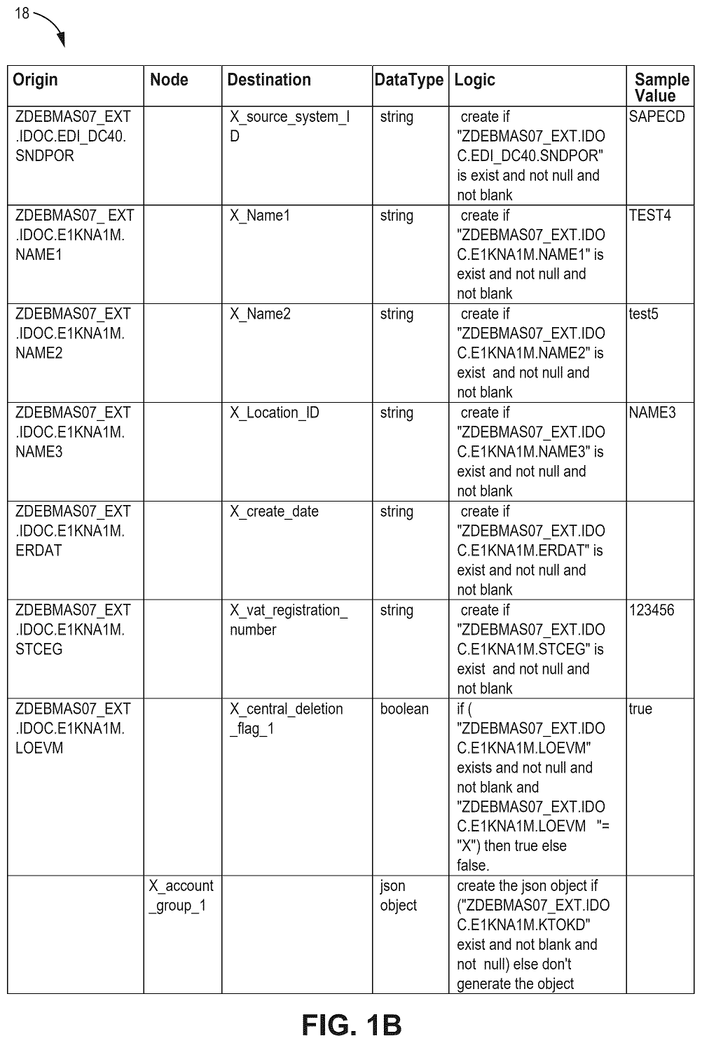

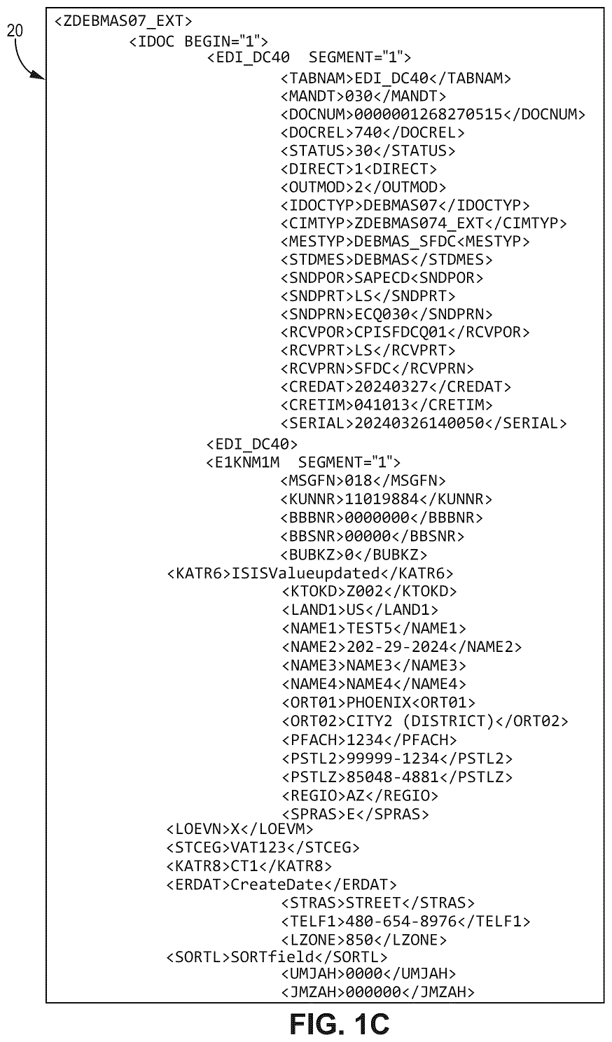

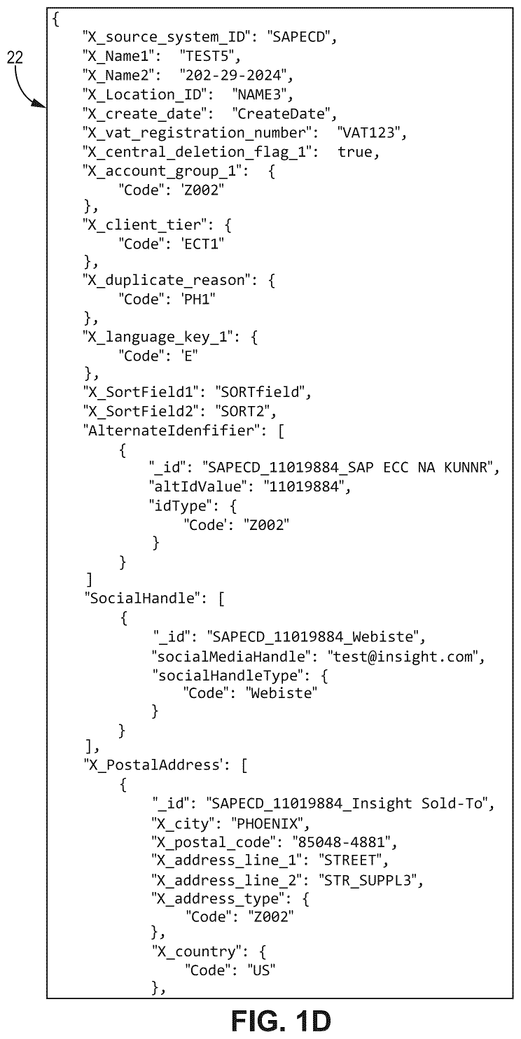

FIG. 1A is a block schematic diagram with process flow of an example integration generation system 10 for use with LLM 12 to generate complete integration path 14 from technical specification document 16 (having mapping guide 18, origin information field “OIF” template 20, and destination information “DIF” template 22). FIG. 1B is an example mapping guide 18, FIG. 1C is an example OIF template 20, and FIG. 1D is an example DIF template 22. The example described herein formulates software code and/or other digital instructions/paths to allow for a first application (e.g., computer software program) to communicate information to a second application (e.g., computer software program) in a format, configuration, organization, etc. that is acceptable by and useable by the second application. This disclosure describes one “integration” as this ability for the first application to communicate information (i.e., specified information fields) to the second application. For the second application to communicate information to the first application, another “integration” would need to be generated by, for example, the systems and methods described herein.

Integration generation system 10 (hereinafter also referred to as just “system 10”) can function with and/or further include, among other components not expressly disclosed herein, first designated location 24A (within which digital data 23 can be present/stored temporarily and/or long-term), integration generation program/application 26 (hereinafter also referred to as just “program 26”), LLM 12 (which may also be a separate and distinct component from system 10), second designation location 24B, and code editor & validator 28 (which may also be one or multiple components separate and distinct from system 10 and/or from each other). Integration generation program 26 can include computer processor 30, storage media 32, user interface 34, and/or prompt generator & assembler 36 to generate and/or communicate prompt 40 to LLM 12. LLM 12 can generate software code that includes partial integration path 42, which can be provided, saved, and/or otherwise accessed at second designated location 24B. Code editor & validator 28 can use, edit, modify, add to, and/or otherwise alter partial integration path 42 by associating/adding to partial integration path 42: 1) a first link/path 44 to connect a first application to the integration path (e.g., add software code to partial integration path 42 that, when executed, allows for the communication of information from connection points/nodes of the first application to the inputs of partial integration path 42); and 2) a second link/path 46 to connect the integration path to a second application (e.g., add software code to partial integration path 42 that, when executed, allows for the outputs of partial integration path 42 to be communicated to connection points/nodes of the second application). Thus, first application to origin path 44 and second application to destination path 46 complete the integration path 14 such that information from the first application can be communicated to the second application by performing the instructions/path(s) set out in complete integration path 14.

FIG. 1A focuses on hardware and/or software components of system 10 and related components (e.g., LLM 12). FIG. 1A is provided as an illustrative example of general hardware and/or software systems for performing the capabilities described herein. The components presented in FIG. 1A, particularly including models/modules 12, 26, 28, and 36 (and associated components) can be omitted or replaced with analogous hardware and/or software in different architectures without departing from the scope and spirit of the present disclosure.

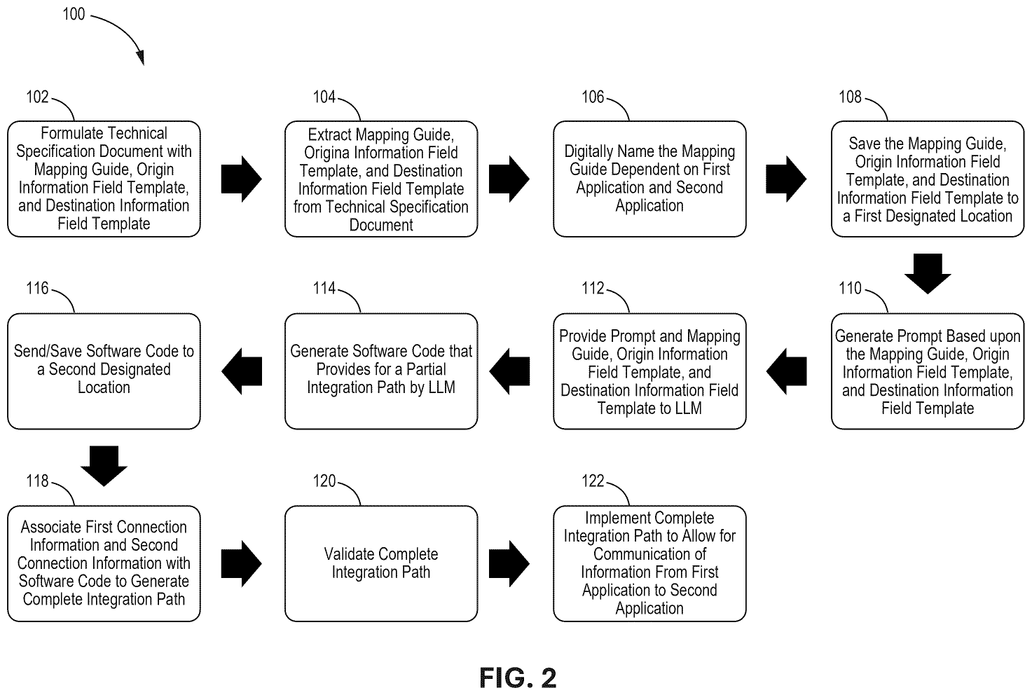

System 10 (and process 100 described with regards to FIG. 2) can include other steps, components, models, modules, configurations, and/or features not expressly disclosed herein that are suitable for generating a complete integration path 14 to allow for communication of information from a first application to a second application. For example, system 10 can include any number of digital/electronic storage media (e.g., storage media 32) for storing digital files, documents, data, information, software code, integration paths, and/or executable instructions. System 10 can include any number of computer processors (e.g., processor 30) for performing tasks/instructions with regards to system 10 and/or process 100. Further, system 10 can allow for communication via wired or wireless communication methods between components of system 10 and/or between other components, systems, designated locations 24A and 24B, storage media, applications, and/or LLM 12 distant from system 10. System 10 (and/or the components of system 10) is described herein as including one or multiple “models” and/or “modules,” which can be any hardware and/or software for performing the tasks, functionality, and/or capabilities described herein. These “models” and/or “modules” can be instantiated in dedicated hardware and/or software, and/or can be defined functionally and use shared hardware and/or software.

Additionally, system 10, program 26, and/or other components of system 10 can each be a discrete assembly or be formed by one or more components capable of individually or collectively implementing the functionalities described herein. In some examples, system 10 and/or the components of system 10 can be implemented as a plurality of discrete circuitry subassemblies. In some examples, one, multiple, or all components of system 10 and/or program 26 can include and/or be implemented at least in part on a smartphone or tablet, among other options. In some examples, one, multiple, or all components of system 10 and/or program 26 can include and/or be implemented as downloadable software in the form of a mobile application. The mobile application can be implemented on a computing device, such as a personal computer, tablet, smartphone, and/or smartwatch, among other suitable devices. One, multiple, or all components of system 10 and/or program 26 can be considered to form a single computing device even when distributed across multiple component computing devices. System 10 and/or program 26 can include a configuration in which one, multiple, or all of the functions described herein are performed by different components. System 10 and/or program 26 can include various components for performing the functions described in this disclosure, such as processors 30, storage media 32, and/or user interface 34.

The information needed to generate complete integration path 14 can be in technical specification document 16, which can be an electronic and/or hard copy document/file that includes information regarding the desired integration, such as information relevant to the application from which data is needed (e.g., the first application), the application to which the data is provided/used (e.g., the second application), the formats that the data (e.g., fields of information) is provided by the first application, the formats that the data (e.g., fields of information) can be received by the second application, the steps needed to transform the information from one format to another, access and/or security information needed to access and/or otherwise obtain data/information, and/or other information necessary to generate complete integration path 14. Technical specification document 16 can be automatically generated by system 10 depending on information from an individual, company, entity, programmer, engineer, etc. that desires for the generation of complete integration path 14. In one example, technical specification document 16 is created by a programmer/engineer based upon discussions and/or information from a client that desires for the integration to be generated. In another example, an individual provides information to system 10 and/or a software program that then generates a technical specification document 16 based upon the information. In this example, the individual can provide that information as prompted by a program/application, such as by prompting the individual to provide information via dialogue boxes and/or drop-down selections/lists.

Technical specification document 16 can include and/or otherwise be associated with three sets of information: mapping guide 16, OIF template 20, and/or DIF template 22. Mapping guide 16 provides information necessary for LLM 12 to generate the software code/partial integration path 42 to allow for the communication of information from the first application to the second application. Mapping guide 18 can include, for example, the formats of information provided by the first application that is to be used by the second application, the formats of information that can be accepted by the second application, some or all information fields for the origin/first application, some or all information fields for the destination/second application, sample values for those information fields, a data type for each information field, node data, and logic detailing how the information field is to be transformed/created from the origin to the destination. An example mapping guide 18 is shown in FIG. 1B. The example mapping guide 18 in FIG. 1B is provided as an excerpt and may not show the entirety of a mapping guide that; when used by integration generation program 26, LLM 12, and/or code editor & validator 28; may not result in a complete and functional integration path 14. In some examples, mapping guide 18 can include hundreds or more rows of entries and/or hundreds or more columns of information/data corresponding to those entries as is necessary to generate partial integration path 42 and/or complete integration path 14 by system 10 (including and/or associated with LLM 12). Mapping guide 18 can be configured, oriented, formatted, and/or otherwise saved in any digital and/or hard copy arrangement. In one example, mapping guide 18 is a spreadsheet, such as a Microsoft Excel spreadsheet. In another example, mapping guide 18 is a text file.

OIF template 20 can include multiple information fields that are able to be communicated from the first application with each information field including at least one corresponding sample value even if that specific information field is not intended to be communicated to the second application. The sample values can be values that are not specific to the first application but instead are placeholder values to show LLM 12 the type of information that is to be generated in that particular field of information during the generation of partial integration path 42. OIF template 20 having sample values in all information fields, even if that information field is not one that is to be communicated to the second application via complete integration path 14, is important for LLM 12 to be able to generate a partial integration path 42 that includes instructions to accurately and completely communicate information from the first application to the second application. Without all sample values in all information fields of OIF template 20, LLM 12 may generate an inaccurate and/or incomplete partial integration path 42. Further, OIF template 20 having sample values in all information fields may be important to allow for integration generation program 26 to generate a complete and accurate prompt 40 to LLM 12. An example OIF template 20 is shown in FIG. 1C. The example OIF template 20 shown in FIG. 1C is provided as an excerpt and may not show the entirety of OIF template 20. In some examples, OIF template 20 can include hundreds or more lines of information as is necessary to generate partial integration path 42 and/or complete integration path 14 by system 10 (including and/or associated with LLM 12). Similar to mapping guide 18, OIF template 20 can be configured, oriented, formatted, and/or otherwise saved in any digital and/or hard copy arrangement. In one example, OIF template 20 is a text file (e.g., .txt file).

Similarly, DIF template 22 can include multiple information fields that are able to be received by the second application with each information field including at least one corresponding sample value even if that specific information field is not intended to be received by the second application from the first application. The sample values can be values that are not specific to the second application but instead are placeholder values to show LLM 12 the type of information that is to be generated in that particular field of information during the generation of particle integration path 42. DIF template 22 having sample values in all information fields, even if that information field is not one that is to be communicated to second application via complete integration path 14, is important for LLM 12 to be able to generate a partial integration path 42 that includes instructions to accurately and completely communication information from the first application to the second application. Without all sample values in all information fields of DIF template 22, LLM 12 may generate an inaccurate and/or incomplete partial integration path 42. Further, DIF template 22 having sample values in all information fields may be important to allow for integration generation program 26 to generate a complete and accurate prompt 40 to LLM 12. An example DIF template 22 is shown in FIG. 1D. The example DIF template 22 shown in FIG. 1D is provided as an excerpt and may not show the entirety of DIF template 22. In some examples, DIF template 22 can include hundreds or more lines of information as is necessary to generate partial integration path 42 and/or complete integration path 12 by system 10 (including and/or associated with LLM 12). Similar to mapping guide 18, DIF template 22 can be configured, oriented, formatted, and/or otherwise saved in any digital and/or hard copy arrangement. In one example, DIF template 22 is a text file (e.g., .txt file).

In the example shown in FIG. 1A and described herein, mapping guide 18, OIF template 20, and/or DIF template 22 may not be included in and/or otherwise associated with technical specification document 16. Rather, one, multiple, and/or all three electronic documents and/or files may be stand-alone documents/files and/or associated with other documents/files having information necessary for system 10 to generate complete integration path 14. In one example, mapping guide 18, OIF template 20, and DIF template 22 can be combined into one document/file or can be separate documents/files as desired. System 10 can be configured to accommodate other configurations, formats, etc. of mapping guide 18, OIF template 20, and/or DIF template 22.

Technical specification document 16 and/or mapping guide 18, OIF template 20, and/or DIF template 22 can be saved to and/or otherwise associated with first designated location 24A, which can be a digital folder and/or other storage media (e.g., storage media 32) capable of storing digital files. Technical specification document 16 and/or mapping guide 18, OIF template 20, and/or DIF template 22 can be stored in first designated location 24A as digital data 23. first designated location 24A can also be referred to herein as first designated digital memory location 24A and, for example, can be storage media that is not directly accessible by a user/operator. For example, integration generation program 26 and/or another component of system 10 can be configured to formulate/extract mapping guide 18, OIF template 20, and/or DIF template 22 and temporarily and/or long-term save/store mapping guide 18, OIF template 20, and/or DIF template 22 as digital data 23 in first designated digital memory location 24A for further use by system 10/integration generation program 26.

Integration generation program 26 can be configured to continually monitor first designated digital memory location 24A for the presence of digital data 23 saved/stored at/in first designated digital memory location 24A for use in generating prompt 40 and the integration generation process. In response to the presence of digital data 23 in first designated digital memory location 23A, integration generation program 26 can be configured to evaluate digital data 23 to determine whether digital data 23 includes all information necessary to generate prompt 40, such as mapping guide 18, OIF template 20, and/or DIF template 22. In response to the determination by integration generation program 26 that digital data 23 includes all necessary information (e.g., mapping guide 18, OIF template 20, and/or DIF template 22), integration generation program 26 can be configured to automatically initiate the generation of prompt 40.

First designated location 24A can be any digital/electronic location/system, including storage mediate 32 associated with program 26, a cloud storage system, and another type of electronic storage. As described above, in one example, program 26 monitors first designated location 24A for the addition of files/documents (such as digital data 23). Upon the detection of the necessary files/documents, program 26 can automatically begin formulating prompt 40 and, upon completion of the prompt 40, provide prompt 40 along with other necessary information to LLM 12.

First designated location 24A can be configured to store other files/documents than those described above as well as more than one of each of the files/documents. In one example, multiple OIF templates 20 and multiple DIF templates 22 are saved to first designated location 24A and, as described below, LLM 12 is configured to generate partial integration path 42 (which is then used to generate complete integration path 14) that accommodates/allows for the communication of all information fields in the multiple OIF templates 20 and DIF templates 22. Thus, this capability of system 10 allows for integrations that can be more broadly used than just integrations specific to the information fields set out in one OIF template 20 and/or DIF template 22. In another example, system 10 can be configured to accommodate multiple mapping guides 18 saved/stored in first designated location 24A, such as generating integration paths 42 and/or 14 for each mapping guide 18 concurrently and/or in series. Further, system 10 can be configured to generate just one integration path 42 and/or 14 (e.g., one set of software code/instructions) that provides for the exchange of information between more than two applications. Thus, multiple mapping guides 18 can be added to, stored in, saved to, and/or otherwise accessed at first designated location 24A.

Not only can program 26 use the content of mapping guide 18, OIF template 20, and/or DIF template 22 to generate prompt 40 for LLM 12 to generate partial integration path 42 and/or for code editor & validator 28 to generate complete integration path 14, but program 26 can be configured to generate prompt 40 from the naming convention of mapping guide 18, OIF template 20, and/or DIF template 22 as those files/documents are saved in storage media, such as in first designated location 24A. For example, mapping guide 18 can be named (e.g., as it appears in first designated location 24A) as “[integration type] _mapping_[origin format] _to_[destination format].” This naming convention can provide information to program 26 as to the type of integration to be generated, the file format of the origin application (e.g., the first application), and the file format of the destination application (e.g., the second application). Program 26 can use this information to generate prompts 40 for LLM 12. For example, mapping guide 18 can be digitally/electronically named, in first designated location 24A, “edm_mapping_xml_to_json” to provide program 26 information describing that the integration type is “edm,” the origin application file format is an Excel file format (e.g., xml), and that the destination application file format is a JSON file format. The integration type “edm” in this example may be the title of the integration to allow for individuals working on/with system 10 to identify the input information (documents/files 16, 18, 20, and/or 22), identify the outputs (partial integration path 42 and/or complete integration path 14), and/or identify any other information associated with the integration. This is one example of mapping guide 18, and this information can be provided to program 26 via other methods and/or files.

Upon the addition of technical specification document(s) 16, mapping guide(s) 18, OIF template(s) 20, and/or DIF template(s) 22 to first designation location 24A and/or being made accessible by program 26, program 26 can generate prompt 40 and provide (and/or otherwise make accessible) prompt 40 to LLM 12. Integration generation program 26 can include other components not expressly disclosed herein. Further, program 26 can function in association with any of the other components of system 10 and/or can include and/or use common components, such as computer processor 30, storage media 32, and/or user interface 34.

Program 26, system 10, and/or the other components of system 10 can include one or more computer/data processors 30 (hereinafter also referred to just as “processor 30”). As described herein, processor 30 can be one or multiple processors used by program 26 and/or other components of system 10. Multiple processor 30 can have the same or differing configurations, capabilities, etc. with one or multiple processors 30 configured to function in conjunction with one another and/or function independently. In general, processor 30 can include any or more than one of a processor, a microprocessor, a controller, a digital signal processor (DSP), an application specific integrated circuit (ASIC), a field-programmable gate array (FPGA), or other equivalent discrete or integrated logic circuitry. Processor 30 can perform instructions stored within storage media 32 (or located elsewhere), and/or processor 30 can include memory such that processor 30 is able to store instructions and perform the functions described herein. Additionally, processor 30 can perform other computing processes described herein, such as the functions performed by any of the components of system 10 and/or any other systems/components.

Program 26 (and/or the components of system 10) can also include storage media 32. As described herein, storage media 32 can be one or multiple storage media having the same or differing configurations, capabilities, etc. with storage media 32 configured to function in conjunction with one another and/or function independently. For example, storage media 32 can be, include, and/or function in conjunction with first designated location 24A and/or second designated location 24B. Storage media 32 is configured to store information (such as technical specification 16, mapping guide 18, OIF template 20, DIF template 22, prompt 40, partial integration path 42, complete integration path 14, first application to origin link/path 44, and/or destination to second application link/path 46) and, in some examples, can be described as a computer-readable storage medium, media, and/or memory. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, storage media 32 is temporary memory. As used herein, a temporary memory refers to a memory having a primary purpose that is not long-term storage. Storage media 32, in some examples, is described as volatile memory. As used herein, a volatile memory refers to a memory that does not maintain stored contents when power to storage media 32 is turned off. Examples of volatile memories can include random access memories (RAM), dynamic random access memories (DRAM), static random access memories (SRAM), and other forms of volatile memories. In some examples, the storage media/memory is used to store program instructions for execution by the processor. The memory, in one example, is used by software or applications running on and/or in conjunction with system 10 to temporarily store information during program execution.

Storage media 32 can be configured to store larger amounts of information than volatile memory. Storage media 32 can further be configured for long-term storage of information. In some examples, storage media 32 include non-volatile storage elements. Examples of such non-volatile storage elements can include, for example, magnetic hard discs, optical discs, floppy discs, flash memories, cloud storage media, or forms of electrically programmable memories (EPROM) or electrically erasable and programmable (EEPROM) memories. Additionally, storage media 32 can be digital/electronic storage in the “cloud” that are distant from program 26 and/or the other components of system 10.

Program 26 and/or the other components of system 10 can also include user interface 34. As described herein, user interface 34 can be one or multiple interfaces used by one, multiple, or all of program 26 and/or the other components of system 10 (as well as other components shown in FIG. 1A). User interface 34 can include multiple user interfaces have the same or differing configurations, capabilities, etc. with user interfaces 34 configured to function in conjunction with one another and/or function independently. User interface 34 can be an input and/or output device and enable an operator/user to control operation, modification, view of data, etc. of technical specification 16, mapping guide 18, OIF template 20, DIF template 22, prompt 40, partial integration path 42, complete integration path 14, first application to origin link/path 44, destination to second application link/path 46 and/or the other information and/or systems/components within program 26 and/or the other components of system 10 and/or in communication with program 26 and/or the other components of system 10. For example, user interface 34 can be configured to receive inputs; such as technical specification document 16, mapping guide 18, OIF template 20, and DIF template 22; and/or provide information, such as prompt 40, partial integration path 42, and complete integration path 14. User interface 34 can include one or more of a sound card, a video graphics card, a speaker, a display device (e.g., a liquid crystal display (LCD), a light emitting diode (LED) display, an organic light emitting diode (OLED) display, etc.), a touchscreen, a keyboard, a mouse, a joystick, and/or other type of device for facilitating input and/or output of information in a form understandable to users and/or machines. In one example, a user, operator, and/or other individual can use user interface 34 to view and/or alter any of the information associated with program 26 and/or the other components of system 10.

Program 26 can include and/or function in conjunction with prompt generator & assembler 36 to generate prompt 40 and/or provide prompt 40 to LLM 12. Prompt generator & assembler 36 and/or LLM 12 can include and/or function in conjunction with program 26 and/or any other components of system 10 (such as processor 30, storage media 32, and/or user interface 34). Prompt generator & assembler 36 and LLM 12 can work together to determine partial integration path 42 based upon prompt 40 (which can include at least a portion of technical specification document 16, mapping guide 18, OIF template 20, and/or DIF template 22). Additionally and/or alternatively, prompt generator & assembler 36 and/or LLM 12 can determine/generate other information. The other components of system 10 can receive information from and/or provide information to prompt generator & assembler 36 and/or LLM 12. While shown in FIG. 1A as being a component of program 26, prompt generator & assembler 36 can be separate and distinct from program 26 and in wired and/or wireless communication with program 26 and/or the other components of system 10. Similarly, while shown in FIG. 1A as being separate and distinct from program 26 and/or system 10, LLM 12 can be within system 10 (e.g., a component of system 10).

Prompt generator & assembler 36 can be configured to prompt/request LLM 12 to perform various specified tasks to determine/generate software code that, when executed, provides for a partial integration path 42 for the communication of information from an origin to a destination. Prompt generator & assembler 36 can be configured to prompt/request LLM 12 to perform other tasks and/or generate other outputs not expressly disclosed herein. Prompt generator & assembler 36 can be configured to provide and/or otherwise allow access to other information useful and/or necessary for LLM 12 to perform the requested tasks and/or instructions, such as all or portions of one or multiple technical specification documents 16, mapping guide 18, OIF template 20, and/or DIF template 22. In one example, prompt generator & assembler 36 generates and/or provides prompt 40 to LLM 12 with prompt 40 being dependent upon files/documents 16, 18, 20, and/or 22 and/or the naming conventions of those files/documents. Prompt 40 can include a request and/or instructions for LLM 12 and any information useful to LLM 12 in determining partial integration path 42 responsive to prompt 40. The prompt(s) 40 as generated, assembled, and/or otherwise used by prompt generator & assembler 36 can include any information, such as questions, instructions, and/or tasks for LLM 12 to answer/perform.

Additionally and/or alternatively, prompt 40 can include two parts: 1) a system portion that includes generic instructions/information (generic to all prompts 40 independent of the first application, second application, and the information to be communicated therebetween); and 2) a user portion that includes specific instructions/information (specific to/dependent upon mapping guide 18, OIF template 20, DIF template 22, and/or other information specific to the first application, second application, and the information to be communicated therebetween). For example, the system portion of prompt 40 can include requesting that LLM 12 is an expert software engineer/developer/programmer. The user portion of prompt 40, for example, can include instructions similar to the following: “Generate a Groovy script that will convert this: XML data labelled ‘origin’ into the JSON format defined with the mapping guide that is in CSV format labelled ‘Mapping Guide.’ An example of the expected output is in the labelled ‘destination’ below.” the user portion of prompt 40 can further include a portion of or all of the corresponding mapping guide 18, OIF template 20, and/or DIF template 22. Prompt 40 provided and/or otherwise made accessible to LLM 12 as generated, assembled, etc. by prompt generator & assembler 36 can include other information, request LLM 12 to perform other determinations, and/or request LLM 12 to make those determinations in a variety of different ways/processes.

The request to LLM 12 by prompt generator & assembler 36 can be a simple request/prompt that can include only one question/query or can be a complex/compound request/prompt that can include/request a series of separate steps/tasks performed sequentially, concurrently, and/or in another fashion to return desired results. Prompt generator & assembler 36 can be configured to generate and/or include any information, requests, etc. in the one and/or multiple prompts 40 to LLM 12. In one example, each prompt 40 to LLM 12 regarding an integration is newly generated by prompt generator & assembler 36 while in another example, a portion and/or all of a prior prompt 40 is reused to generate a subsequent prompt 40 to LLM 12 regarding a different integration.

Prompt generator & assembler 36 can be configured to generate, assemble, etc. one and/or multiple prompts 40 manually as initiated and/or generated by an operator, and/or prompt generator & assembler 36 can be configured to automatically generate/assemble one or multiple prompts 40 for LLM 12 in response to, for example, the reception of and/or access to technical specification document 16, mapping guide 18, OIF template 20, and/or DIF template 22 at first designated location 24A and/or at another location. Further, prompt generator & assembler 36 can have the capability to communicate prompts 40 to LLM 12 via wired and/or wireless communication. In one example, prompt generator & assembler 36: 1) generates prompt 40 from technical specification document 16, mapping guide 18, OIF template 20, and/or DIF template 22; 2) assembles prompt 40 that includes the system portion, user portion, and/or at least a portion of technical specification document 16, mapping guide 18, OIF template 20, and/or DIF template 22; and 3) communicates prompt 40 to LLM 12 (and/or otherwise makes prompt 40 available for access and/or use by LLM 12).

Program 26 and/or system 10 can include and/or work in conjunction with, receive information from, and/or provide information to one or multiple LLMs 12. In one configuration, LLM 12 is a separate and distinct component/system from system 10, and LLM 12 accesses and/or otherwise receives prompts 40 from system 10 and/or program 26 via, for example, the internet. In another configuration, LLM 12 can be within (e.g., a component of) and/or work in conjunction with system 10.

LLM 12 and similar models are increasingly common deep learning algorithms that can recognize, summarize, describe, translate, predict, and/or generate content using large datasets, which can include information available and/or accessed on the internet. LLM 12 can be used to process simple or complex requests which, for example, demand retrieval of data from multiple or specialized sources and/or assemble outputs (e.g., natural language, computer software code, lists, graphs, and/or other information configurations) from the retrieved data based on identified criteria. LLM 12 can include a generalized LLM, specialized LLM, and/or other models. LLM 12 can be one or multiple models and/or other systems known to one of skill in the industry for retrieving, organizing, summarizing, manipulating, and/or performing other functions with regards to information in response to one or multiple requests from, for example, prompt generator & assembler 36 and/or system 10. LLM 12 can be configured to communicate with (e.g., provide information to and receive information from) program 26 and/or the other components of system 40 and/or other components/systems, such as a user.

In response to one or multiple prompts 40, LLM 12 can be configured to determine/generate at least one output that is responsive to and/or satisfies prompt 40, such as generating partial integration path 42 (e.g., software code that includes instructions that, when executed, allows for the communication of information from an origin to a destination). Partial integration path 42 can include and/or depend upon mapping guide 18, OIF template 20, DIF template 22, and the other information included in prompt 40. The output from LLM 12 can include information other than partial integration path 42 and/or can provide partial integration path 42 in any configuration, format, and/or organization as desired and/or requested in prompt 40. In one example, as requested by prompt 40, LLM 12 can generate partial integration path 42 in a Groovy script software coding language/format. LLM 12 can make partial integration path 42 available to a user/operator via any methods and/or components, such as via user interface 34 and/or by saving partial integration path 42 (and/or associated information) to second designated location 24B. LLM 12 can be configured to manually generate partial integration path 42 as initiated by a user/operator, and/or LLM 12 can be configured to automatically generate partial integration path 42 in response to, for example, the access to and/or reception of prompt 40 and/or in response to any other triggering events or instructions.

Partial integration path 42, as generated by LLM 12 in response to prompt 40, can be and/or include software code that includes instructions that, when executed (e.g., by processor 30 and/or another system), allows for information from an origin application (as set out in mapping guide 18 and/or OIF template 20) to a destination application (as set out in mapping guide 18 and/or DIF template 22). Partial integration path 42, if executed, may not provide for the communication of information from the first application to the second application because specific connector information needed to link partial integration path 42 to the first application and the second application may not be included in mapping guide 18, OIF template 20, and/or DIF template 22 (e.g., specific connection points for the first application and/or the second application). Thus, as described below, further action may be needed to link the first application (e.g., the outputs of information from the first application) to the connector nodes/points of the origin application as set out in partial integration path 42 and to link the connector nodes/points of the destination application as set out in partial integration path 42 to the second application (e.g., the inputs of information to the second application). Partial integration path 42 can be generated by LLM 12 in any format, configuration, etc. In one example, partial integration path 42 is generated so as to be software code in Groovy script language/format. Partial integration path 42 can include other information in addition to and/or alternative to the software code.

LLM 12 and/or system 10 can be configured to store/save partial integration path 42 and/or other outputs from/generated by LLM 12 to second designated location 24B. Second designated location 24B can be the same digital folder and/or electronic storage location as first designated location 24A, or second designated location 24B can be different from first designated location 24A. Second designated location 24B can have the same configurations, capabilities, organizations, etc. as first designated location 24A. Second designated location 24B can be any digital/electronic location/system, including storage mediate 32 associated with program 26, a cloud storage system, and/or another type of electronic storage. Second designated location 24B can be at a digital/electronic location that is known to the users/operators of system 10 as a location to which partial integration path 42 is temporarily and/or permanently saved/stored by LLM 12 after generation by LLM 12. Thus, the users/operators can then access and/or otherwise use partial integration path 42 for further evaluation, validation, and/or modification. For example, LLM 12 generates partial integration path 42, saves partial integration path 42 to second designated location 24B, and a user/operator accessed partial integration path 42 at second designated location 24B to begin further editing and/or validating, such as through the use of code editor & validator 28. In another example, code editor & validator 28 monitors second designated location 24B for the addition of partial integration path 42 and, upon “seeing” partial integration path 42 in second designated location 24B, code editor & validator 28 is automatically triggered to perform the tasks/instructions set out below.

System 10 and/or integration generation program 26 can include and/or function in conjunction with code editor & validator 28. Code editor & validator 28 can include and/or function in conjunction with any of other components of system 10 (such as processor 30, storage media 32, and/or user interface 34) and/or include other components/capabilities not expressly disclosed herein and/or shown in FIG. 1A. For example, code editor & validator 28 can include its own processor(s), storage media, and user interface to provide for the editing and/or validation of partial integration path 42, first application to origin path 44, destination to second application path 46, and/or complete integration path 14. In a first example, code editor & validator 28 is one or multiple computer software programs/applications that allow for one or multiple users/operators to edit partial integration path 42 to associate first application to origin path 44 with integration path 42 and to associate destination to second application path 46 with partial integration path 42 to create complete integration path 14.

In a second example, code editor & validator 28 automatically generates (from connection information in mapping guide 18, OIF template 20, DIF template 22, technical specification document 16, and/or other information) first application to origin path 44 and/or destination to second application path 46 without or with little user/operator intervention. In this second example, code editor & validator 28 can work in conjunction with program 26, LLM 12, and/or other components of system 10. Thus, code editor & validator 28 (and/or a user/operator using code editor & validator 28) can use connection information to create the complete integration path 14 from the first application to the second application by associating (with the software code of partial integration path 42) connection information that links the origin (as set out in the partial integration path 42) to the first application and associating connection information that links the destination (as set out in partial integration path 42) to the second application that, when performed by at least one computer processor, program, and/or application, allows for the communication of information from the first application to the second application.

In a third example, code editor & validator 28 can allow for one or multiple users/operators to and/or automatically perform steps/instructions to validate partial integration path 42, first application to origin path 44, destination to second application path 46, and/or complete integration path 14 to ensure that the software code/instructions, when performed, allow for the transfer of information from the first application to the second application. Upon the addition of first application to origin path 44 and destination to second application path 46 to partial integration path 42 (and potentially the validation of complete integration path 14), complete integration path is 14 is finished and can be operational. Thus, complete integration path 14 can be saved at, added to, accessed by, and/or otherwise used by one or multiple software programs, applications, and/or APIs to effectuate the communication of information from the first application to the second application. Code editor & validator 28 can include other components, configurations, functionalities, and/or capabilities not expressly disclosed herein.

As described above, integration generation system 10 generates complete integration path 14 that includes computer software that, when executed/performed, allows for the communication of information from the first application to the second application. System 10 provides for a great increase in time and efficiency and a reduction in costs and effort to generate complete integration path 14 by leveraging LLM 12 to generate partial integration path 42 (e.g., generate software code) dependent upon prompt 40, mapping guide 18, OIF template 20, and/or DIF template 22. The information provided to LLM 12 by system 10 must be complete, explained, and provided in a specific organization and format to ensure that the output from LLM 12 is complete and accurate to avoid the need for edits/alterations thereafter, which would increase the costs and effort to generate complete integration path 14. System 10 reduces the amount of time, effort, and resources (e.g., cost) needed to generate complete integration path 14 greatly, for example, by 80% or more. A process for generating a complete integration path to allow for the communication of information from the first application to the second application is described below with reference to FIG. 2.

FIG. 2 is a method flow chart describing example process 100 for generating a complete integration path to allow for the communication of information from an example first application to an example second application. While process 100 is described herein as being used with regards to integration generation system 10 (and LLM 12), process 100 can be performed by any system(s) having any components, capabilities, configurations, and/or functionalities suitable for performing process 100. Additionally, process 100 can include other steps not expressly disclosed herein and/or can include performing the disclosed steps in any order, multiple times, concurrently, and/or sequentially as is desired and/or necessary to prepare information for use by an LLM and for generation of the complete integration path. Moreover, not all steps of process 100 must be performed, and process 100 can be performed partially and/or entirely in a digital environment by and/or within the systems/components set out in this disclosure, such as system 10 and/or other systems/components.

Additionally and/or alternatively, process 100 and/or one, multiple, or all steps 102-122 can be configured to automatically be performed in response to, for example, the access to and/or reception of information needed to perform that particular step, the performance of the previous step, the availability of resources (e.g., LLM 12) needed to perform that particular step, a schedule detailing when that particular step is to be initiated/began and/or completed, and/or any other triggering events or instructions.

Process 100 can include step 102, which is to formulate, obtain, and/or otherwise access technical specification document 16 with mapping guide 18, OIF template 20, and/or DIF template 22. Technical specification document 16, as described above with regards to system 10, can be an electronic and/or hard copy document/file that includes information needed to create/generate complete integration path 14. Technical specification document 16 can be formulated by a programmer, engineer, and/or other familiar with the desired integration (e.g., communication of information from the first application to the second application). In another example, technical specification document 16 can, in step 102, be automatically generated by system 10 depending on information from an individual, company, entity, programmer, engineer, etc. that desires for the generation of complete integration path 14. In a third example, step 102 includes an individual providing information to system 10 and/or a software program that then generating technical specification document 16 based upon the information and/or based upon inputs provided by a user. Step 102 can be triggered by a variety of events/instructions, such as the addition of the necessary information into the system/program. Step 102 can include saving/storing technical specification document 16 in a specified storage media for later access and/or use.

Next, process 100 can include step 104, which is to extract mapping guide 18, OIF template 20, and DIF template 22 from technical specification document 16. Technical specification document 16 can be in any format having any organizational and/or electronic configuration. In one example, mapping guide 18, OIF template 20, and/or DIF template 22 are present in technical specification document 16 in their entirety and extraction merely includes copying/extracting the “chunk” of information from technical specification document 16. In another example, the information needed to formulate mapping guide 18, OIF template 20, and/or DIF template 22 are dispersed throughout technical specification document 16 and/or needs to be derived from information within technical specification document 16 so extraction requires multiple steps and potentially the assembly of the information into mapping guide 18, OIF template 20, and/or DIF template 22. Step 104 can be performed automatically, for example, by system 10 and/or any of the components of system 10, such as integration generation program 26. Step 104 can be automatically triggered to be performed by a variety of events/instructions, such as obtaining and/or getting access to technical specification document 16. System 10, in step 104, can be configured to analyze technical specification document 16, categorize and/or otherwise recognize the information needed for each document/file, perform any derivations/determinations of information needed for each document/file based upon the technical specification document 16, extract the necessary information, and/or assemble, organize, and/or reformat the information to form the mapping guide 18, OIF template 20, and/or DIF template 22. In one example, mapping guide 18, OIF template 20, and/or DIF template 22 are formulated independently without technical specification document 16 as process 100 does not include the formulation and/or use of technical specification document 16 but rather includes generating and/or extracting mapping guide 18, OIF template 20, and/or DIF template 22 from other sources. Thus, process 100 can include altered step 102 and/or 104 depending on the accessible information.

Process 100 can then include step 106, which is to digitally name mapping guide 18 depending on the first application and the second application (e.g., the first application that is to communicate information to the second application as set out in the technical specification document 16 and/or accessible information). Step 106 can include naming mapping guide 18 (as it appears, for example, in first designated location 24A described in step 108) as “[integration type] _mapping_[origin format] _to_[destination format].” This naming convention can provide information to program 26 as to the type of integration to be generated, the file format of the origin application (e.g., the first application), and/or the file format of the destination application (e.g., the second application). Step 106 can, as described in step 110, allow for the information in the naming convention of mapping guide 18 to be used to generate prompts 40 for LLM 12. For example, mapping guide 18 can be digitally/electronically named in step 106, in first designated location 24A, “edm_mapping_xml_to_json” to provide program 26 information describing that the integration type is “edm,” the origin application file format is an Excel file format (e.g., xml), and that the destination application file format is a JSON file format. The integration type “edm” in this example may be the title of the integration to allow for individuals working on/with system 10 to identify the input information (documents/files 16, 18, 20, and/or 22), identify the outputs (partial integration path 42 and/or complete integration path 14), and/or identify any other information associated with the integration. This is one example of the naming convention of mapping guide 18, and this information can be provided to program 26 in step 106 via other methods and/or files. Step 106 can be performed automatically by system 10 and/or any of the components of system 10, such as integration generation program 26, based upon the desired integration as set out in the accessible information, such as technical specification document 16. Thus, step 106 can include analyzing technical specification document 16 (and/or mapping guide 18, OIF template 20, and/or DIF template 22) and determining the first application file format and/or the second application file format.

Next, process 100 can include step 108, which is saving/storing the necessary documents/files/information; such as mapping guide 18, OIF template 20, and/or DIF template 22; to first designated location 24A and/or to another location accessible by program 26 (which then uses that information to generate prompt 40 in step 110). As described above with regards to system 10, first designated location 24A can be any electronic/digital storage media to which the necessary information can be saved/stored for access by program 26. Step 108 can include automatically saving the necessary information in a specific file format, organization, etc. upon extraction and/or formulation of the specific files/documents/information. As set out in step 106, mapping guide 18 can be saved to and/or otherwise stored in first designated location 24A having a specific naming convention. Step 108 can include the continuous and/or periodic monitoring of first designated location 24A by, for example, program 26 for the presence of digital data 23 (which can include mapping guide 18, OIF template 20, DIF template 22, and/or other information necessary to generate partial integration path 42). Then, step 108 can include, in response to the presences of digital data 23 in first designated location 24A, an evaluation of digital data 23 by, for example, program 26 to determine whether digital data 23 includes all information necessary to generate prompt 40 (in step 110). In response to the determination that digital data 23 includes all necessary information (e.g., mapping guide 18, OIF template 20, and/or DIF template 22), process 100 can include automatically triggering/initiating the generation of prompt 40 (in step 110). Thus, upon program 26 determining/seeing that information has been saved/stored to first designated location 24A in step 108, program 26 can then be automatically triggered to analyze the information in first designated location 24 to determine if there is sufficient information to perform step 110. Then, program 26 can automatically perform step 110 as described below. Thus, step 108 can act as a triggering event that begins the performance of subsequent steps of process 100.

Process 100 can include step 110, which is to generate prompt 40 based upon mapping guide 18, OIF template 20, DIF template 22, and/or any other information regarding the desired communication of information from the first application to the second application. Step 110 can be performed by system 10 and/or any components of system 10, such as integration generation program 26. As described with regards to program 26 above, prompt 40 generated in step 110 can be any request, instructions, etc. to LLM 12 and can include any necessary information useful to LLM 12 to generate software code that provides for partial integration path 42. Prompt 40 generated in step 110 can include two parts: 1) a system portion that includes generic instructions/information (generic to all prompts 40 independent of the first application, second application, and the information to be communicated therebetween); and 2) a user portion that includes specific instructions/information (specific to/dependent upon mapping guide 18, OIF template 20, DIF template 22, and/or other information specific to the first application, second application, and the information to be communicated therebetween). For example, the system portion of prompt 40 can include requesting that LLM 12 is an expert software engineer/developer/programmer. The user portion of prompt 40, for example, can include instructions similar to the following: “Generate a Groovy script that will convert this: XML data labelled ‘origin’ into the JSON format defined with the mapping guide that is in CSV format labelled ‘Mapping Guide.’ An example of the expected output is in the labelled ‘destination’ below.” Prompt 40 generated in step 110 can include other information not expressly disclosed herein that is useful to LLM 12 and/or improves the effectiveness, accuracy, and/or responsiveness of LLM 12 to prompt 40. Step 110 can include generating one or multiple prompts 40 as is necessary for LLM 12 to generate partial integration path 42, and/or step 110 can include using parts or the entirety of a previously generated prompt 40 (i.e., generated during a previous performance of process 100 regarding the integration of other information, applications, etc.). As described above, the initiation of step 110 can be triggered by, for example, the addition of the necessary/accessible information to first designated location 24A and the access to that information by program 26. Step 110 can be performed automatically by program 26 and/or the other components of system 10. For example, program 26 can include and/or function in association with instructions that, when executed, analyze the information (e.g., technical specification document 16, mapping guide 18, OIF template 20, and/or DIF template 22) and generate prompt 40 dependent upon that information and/or other information.

After generating prompt 40 in step 110, process 100 can include step 112, which is to provide and/or otherwise allow access to prompt 40 (that can include useful information, such as portions of and/or all of mapping guide 18, OIF template 20, and/or DIF template 22) by LLM 12. Step 112 can be performed by any of the components of system 10, such as a communication module not expressly shown in FIG. 1A. Step 112 can include providing prompt 40 to LLM 12 as one prompt or a series of prompts that includes text, graphs, files, documents, etc. as is necessary and/or useful to LLM 12 to generate partial integration path 42 regarding the first application and the second application. Step 110 can include initiating a “conversation” with LLM 12 and/or other initial connection steps to access LLM 12. The LLM, as described above with regards to LLM 12 associated with system 10, can be any large language model, generative artificial intelligence model, and/or another system/program. Providing prompt 40 to LLM 12 in step 112 can be performed automatically by, for example, program 26 upon the completion of the generation of prompt 40 and/or at another time, such as according to a predefined schedule (so as to manage resource allocation).

In response to prompt 40, LLM 12 can generate software code that provides for partial integration path 42 in step 114. LLM 12 can generate the software code/partial integration path 42 in any format/language, such as the format/language specified/requested in prompt 40. Step 114, while described herein as being performed by LLM 12, can be performed by any model, system, etc. capable of generating software code/partial integration path 42. Step 112 can be performed automatically by LLM 12 in response to the reception of and/or access to prompt 40.

After generating partial integration path 42 in step 114, process 100 can include step 116, which is sending/saving software code/partial integration path 42 to second designated location 24B. The location to which partial integration path 42 is saved/sent can be specified in prompt 40. Further, the location, which can be any storage media, can be configured to allow for access by LLM 12 to allow for LLM 12 to send/save the output (e.g., software code that includes partial integration path 42) to that digital/electronic location. In one example, second designated location 24B is the same as first designated location 24B such that step 114 includes saving partial integration path 42 to first designated location 24A. Step 114 can allow for access to the software code/partial integration path 42 by any users, operators, programmers, engineers, etc. to review, modify, add to, and/or delete information from partial integration path 42. Saving partial integration path 42 to second designated location 24B in step 114 can be performed automatically by, for example, LLM 12 and/or any components of system 10 in response to the generation and/or reception of the output from LLM 12 (e.g., the software code/partial integration path 42). In one example, LLM 12 generates partial integration path 42 in a dialogue/textual box on a webpage and/or program/application and system 10 (or another component/system) extracts partial integration path 42 and saves it to second designated location 24B.

Next, process 100 can include step 118, which is associating and/or otherwise adding first application to origin path 44 and/or second application to destination path 46 to software code/partial integration path 42 to generate complete integration path 14. As described above with regards to system 10, partial integration path 42 may provide for the steps necessary to effectuate the communication of information from an origin program/application/connection node to a destination program/application/connection node. To get a complete integration path 14 that provides instructions to communicate information from the first application to the second application, it may be necessary to add instructions to partial integration path 42 to link the connection nodes/points (and/or other information) of the first application to the origin as set out in partial integration path 42 and also to link the connection nodes/points (and/or other information) of the second application to the destination as set out in partial integration path 42. Step 118 can be performed manually by a programmer, engineer, user, operator, etc. and/or can be performed automatically by any of the components of system 10 based upon technical specification document 16, mapping guide 18, OIF template 20, DIF template 22, and/or any other information specific to the communication of information from the first application to the second application. The origin and destination as set out in partial integration path 42 can merely be placeholders such that when first application to origin path 44 and/or second application to destination path 46 are added to and/or otherwise associated with partial integration path 42 (e.g., partial integration path 42 is modified), compete integration path 14 is finished, operational, and functional. Step 118 can be performed automatically as triggered by the saving of partial integration path 42 to second designated location 24B, the saving and/or otherwise access to the necessary information (e.g., technical specification document 16, mapping guide 18, OIF template 20, DIF template 22, and/or any other information specific to the communication of information from the first application to the second application), and/or other triggering events and/or at any time, such as based upon a predefined schedule.

In other configurations/processes, step 118 can be performed by LLM 12 depending upon the first application, the second application, the information to be communicated therebetween, the generation of prompt 40 in step 110, the capabilities of LLM 12, and/or other factors. In one example, step 118 is not performed by LLM 12 because some information regarding the first application, the second application, and/or the information to be communicated therebetween is intended to remain confidential so thus is not provided to LLM 12 in prompt 40. In another example, step 118 is not performed by LLM 12 because the connection nodes/points and/or other information required to communicate information from the first application to the second application are confidential, not known at the time of generation of partial integration path 42, require additional authorization, and/or includes other factors not able to be accommodated by LLM 12.

Process 100 can optionally include step 120, which is the validation of complete integration path 14 (after step 118) and/or the validation of partial integration path 42 at any point after step 114. Step 120 can include testing the software code of complete integration path 14, first application to origin path 44, partial integration path 42, and/or destination to second application path 46 to ensure that, when executed, information can be communicated from the first application to the second application as intended/desired by the integration. Step 120 can include manually reviewing portions and/or the entirety of the paths and/or automatically analyzing the paths by, for example, code editor & validator 28. The validation of the paths in step 120 can include other methods, processes, steps, etc. for ensuring the software code, instructions, etc. of the paths effectuate the communication of information as intended by the integration.

Process 100 can include step 122 (or step 122 can be distinct from process 100), which is to implement complete integration path 14 to allow for the communication of information from the first application to the second application. The implementation of complete integration path 14 can be performed manually by an operator, user, programmer, engineer, etc. The effectuation of the complete integration path 14 to allow for the communication of information from the first application to the second application can be performed automatically by one or multiple computer programs, applications, APIs, and/or other software and/or hardware capable of performing the instructions set out in complete integration path 14. The implementation of and/or performance of the integration in step 122 can use any processes, methods, steps, etc. known to one of skill in the technology.

Process 100 can include other steps not expressly disclosed herein and/or not shown in FIG. 2, and/or process 100 can omit steps shown in FIG. 2. For example, process 100 can include training LLM 12. In another example, process 100 can include reviewing, testing, analyzing, saving, and/or otherwise using complete integration path 14 and/or any of the information used in generating complete integration path 14 for further evaluations and/or investigations. Further, process 100 can be performed multiple times to generate one or multiple integration paths.

System 10 and/or process 100 can have other features, steps, functionalities, capabilities, and/or advantages than those described above. For example, system 10/process 100 can include extracting mapping guide 18, OIF template 20, and/or DIF template 22 automatically from information regarding the integration. In another example, system 10/process 100 can include determining a format of the information to be provided by the first application and a format of the information to be received by the second application during integration from mapping guide 18, OIF template 20, and/or DIF template 22. Further, system 10/process 100 can include naming mapping guide 18 depending upon the formats. In a third example, system 10/process 100 can include automatically generating prompt 40 with the user portion of prompt 40 being dependent upon the naming convention of mapping guide 18. In a fourth example, system 10/process 100 can include proving prompt 40 to LLM 12 in a specified format/organization that is configured to allow for LLM 12 to determine an output (e.g., software code that include partial integration path 42) that is complete and responsive. In a fifth example, system 10/process 100 can include generating prompt 40 that solicits LLM 12 to generate software code that provides for the communication of information for all information fields from the origin to the destination as specified in prompt 40, not just the information fields desired for the integration between the first application and the second application.

### Discussion of Possibly Examples

An example method of producing an integration path for the communication of information from a first application to a second application is disclosed herein that includes formulating a mapping guide, an origin information field template, and a destination information field template dependent upon the first application, the second application, and the information that is to be communicated, wherein the origin information field template and the destination information field template each include at least one sample value in each information field that is to be communicated from the first application to the second application. The method can also include digitally naming the mapping guide dependent upon the first application and the second application; continually monitoring, by an integration generation program that functions in conjunction with at least one computer processor, a first designated digital memory location for presence of digital data; and, in response to the presence of the digital data in the first designated digital memory location, evaluating the digital data to determine whether the digital data includes the mapping guide, origin information field template, and destination information field template in the digital data. The method can further include, in response to determining that the digital data includes the mapping guide, origin information field template, and destination information field template, automatically initiating the generation of a prompt for a large language model with the prompt having a system portion that includes a generic instruction and a user portion that includes specific instructions dependent upon the mapping guide, origin information field template, and destination information field template; providing the prompt that at least partially includes the mapping guide, origin information field template, and destination information field template to the large language model that requests the large language model to generate software code that, when executed, provides for a partial integration path for the communication of information from an origin to a destination; receiving the software code from the large language model; and associating, with the software code, first connection information that links the origin to the first application and second connection information that links the destination to the second application to generate a complete integration path that, when performed by at least one computer processor, allows for the communication of information from the first application to the second application.

The method of the preceding paragraph can optionally include, additionally and/or alternatively, any one or more of the following features, configurations, steps, and/or additional components:

The method can further include that formulating the mapping guide, origin information field template, and destination information field template comprises formulating by the integration generation software program.

The method can further include that, in response to formulating the mapping guide, origin information field template, and destination information field template, the method further comprises storing the mapping guide, origin information field template, and destination information field template in the first designated digital memory location.

The method can further include that the specific instructions generated by the prompt are dependent upon the name of the mapping guide.

The method can further include that the name of the mapping guide includes a first file format dependent upon the first application and a second file format dependent upon the second application.

The method can further include that the first file format is the format in which the information is provided by the first application and the second file format is the format in which the information is received by the second application.

The method can further include that the step of formulating the mapping guide, origin information field template, and destination information field template further comprises accessing a technical specification document regarding the integration and extracting the mapping guide, origin information field template, and destination information field template from the technical specification document.

The method can further include that the step of formulating the mapping guide further comprises formulating the technical specification document dependent upon a business requirement document and a functional specification document.

The method can further include that the steps of accessing the technical specification document and extracting the mapping guide, origin information field template, and destination information field template from the technical specification document is performed automatically by the integration generation program in response to the technical specification document being stored at a first designated digital memory location.

The method can further include that the prompt includes instruction to the large language model to generate the software code in Groovy script programming language and the software code received from the large language model is in Groovy script programming language.

The method can further include validating the complete integration path to ensure that, when performed, information is communicated from the first application to the second application.

The method can further include that the software code is received from the large language model at a second designated digital memory location.

The method can further include that the origin information field template includes multiple information fields that are able to be communicated from the first application with each information field including at least one corresponding sample value even if that specific information field is not being communicated to the second application.

The method can further include that the destination information field template includes multiple information fields that are able to be received by the second application with each information field including at least one corresponding sample value even if that specific information field is not being received by the second application from the first application.

An example system for producing an integration path for the communication of information from a first application to a second application is disclosed herein that includes a mapping guide that is digitally named dependent upon the first application and the second application, an origin information field template having at least one sample value in each information field that is to be communicated from the first application to the second application, a destination information field template having at least one sample value in each information field that is to be received by the second application from the first application, and an integration generation software program that functions in conjunction with at least one computer processor. The integration generation program can be configured to continually monitor a first designated digital memory location for presence of digital data; in response to the presence of the digital data in the first designated digital memory location, evaluate the digital data to determine whether the digital data includes the mapping guide, origin information field template, and destination information field template; in response to the determination that the digital data includes the mapping guide, origin information field template, and destination information field template, automatically initiate the generation of a prompt for a large language model with the prompt having a system portion that includes a generic instruction and a user portion that includes specific instructions dependent upon the mapping guide, origin information field template, and destination information field template; provide the prompt that at least partially includes the mapping guide, origin information field template, and destination information field template to the large language model that requests the large language model to generate software code that, when executed, provides for a partial integration path for the communication of information from an origin to a destination; and receive the software code from the large language model. The system can further include a complete integration path that, when performed by at least one computer processor, allows for the communication of information from the first application to the second application, the complete integration path having a first connection that links the first application to the origin set out in the software code, the software code that provides instructions for the communication of information from the origin to the destination, and a second connection that links the destination set out in the software code to the second application.

The system of the preceding paragraph can optionally include, additionally and/or alternatively, any one or more of the following features, configurations, steps, and/or additional components:

The system can further includes that the mapping guide, origin information field template, and the destination information field template are formulated by the integration generation software program.

The system can further include that, after formulation, the mapping guide, origin information field template, and the destination information field template are stored in the first designated digital memory location.

The system can further include that the origin information field template includes multiple information fields that are able to be communicated from the first application with each information field including at least one corresponding sample value even if that specific information field is not being communicated to the second application.

The system can further include that the destination information field template includes multiple information fields that are able to be received by the second application with each information field including at least one corresponding sample value even if that specific information field is not being received by the second application from the first application.

The system can further include that the integration generation software program is configured to generate the user portion of the prompt depending on the digital name of the mapping guide.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of producing an integration path for the communication of information from a first application to a second application, the method comprising:
formulating a mapping guide, an origin information field template, and a destination information field template dependent upon the first application, the second application, and the information that is to be communicated, wherein the origin information field template and the destination information field template each include at least one sample value in each information field that is to be communicated from the first application to the second application;
digitally naming the mapping guide dependent upon the first application and the second application;
continually monitoring, by an integration generation software program that functions in conjunction with at least one computer processor, a first designated digital memory location for presence of digital data;
in response to the presence of the digital data in the first designated digital memory location, evaluating the digital data to determine whether the digital data includes the mapping guide, origin information field template, and destination information field template in the digital data;
in response to determining that the digital data includes the mapping guide, origin information field template, and destination information field template, automatically initiating the generation of a prompt for a large language model with the prompt having a system portion that includes a generic instruction and a user portion that includes specific instructions dependent upon the mapping guide, origin information field template, and destination information field template;
providing the prompt that at least partially includes the mapping guide, origin information field template, and destination information field template to the large language model that requests the large language model to generate software code that, when executed, provides for a partial integration path for the communication of information from an origin to a destination;
receiving the software code from the large language model; and
associating, with the software code, first connection information that links the origin to the first application and second connection information that links the destination to the second application to generate a complete integration path that, when performed by at least one computer processor, allows for the communication of information from the first application to the second application.

2. The method of claim 1, wherein formulating the mapping guide, origin information field template, and destination information field template comprises formulating by the integration generation software program.

3. The method of claim 2, wherein, in response to formulating the mapping guide, origin information field template, and destination information field template, the method further comprises:
storing the mapping guide, origin information field template, and destination information field template in the first designated digital memory location.

4. The method of claim 1, wherein the specific instructions generated by the prompt are dependent upon the name of the mapping guide.

5. The method of claim 1, wherein the name of the mapping guide includes a first file format dependent upon the first application and a second file format dependent upon the second application.

6. The method of claim 5, wherein the first file format is the format in which the information is provided by the first application and the second file format is the format in which the information is received by the second application.

7. The method of claim 1, wherein the step of formulating the mapping guide, origin information field template, and destination information field template further comprises:
accessing a technical specification document regarding the integration; and
extracting the mapping guide, origin information field template, and destination information field template from the technical specification document.

8. The method of claim 7, wherein the step of formulating the mapping guide further comprises:
formulating the technical specification document dependent upon a business requirement document and a functional specification document.

9. The method of claim 7, wherein the steps of accessing the technical specification document and extracting the mapping guide, origin information field template, and destination information field template from the technical specification document is performed automatically by the integration generation program in response to the technical specification document being stored at a first designated digital memory location.

10. The method of claim 1, wherein the prompt includes instruction to the large language model to generate the software code in Groovy script programming language and the software code received from the large language model is in Groovy script programming language.

11. The method of claim 1, further comprising:
validating the complete integration path to ensure that, when performed, information is communicated from the first application to the second application.

12. The method of claim 1, wherein the software code is received from the large language model at a second designated digital memory location.

13. The method of claim 1, wherein the origin information field template includes multiple information fields that are able to be communicated from the first application with each information field including at least one corresponding sample value even if that specific information field is not being communicated to the second application.

14. The method of claim 13, wherein the destination information field template includes multiple information fields that are able to be received by the second application with each information field including at least one corresponding sample value even if that specific information field is not being received by the second application from the first application.

15. A system for producing an integration path for the communication of information from a first application to a second application, the system comprising:
a mapping guide that is digitally named dependent upon the first application and the second application;
an origin information field template having at least one sample value in each information field that is to be communicated from the first application to the second application;
a destination information field template having at least one sample value in each information field that is to be received by the second application from the first application;
an integration generation software program that functions in conjunction with at least one computer processor, the integration generation software program being configured to:
continually monitor a first designated digital memory location for presence of digital data;
in response to the presence of the digital data in the first designated digital memory location, evaluate the digital data to determine whether the digital data includes the mapping guide, origin information field template, and destination information field template;
in response to the determination that the digital data includes the mapping guide, origin information field template, and destination information field template, automatically initiate the generation of a prompt for a large language model with the prompt having a system portion that includes a generic instruction and a user portion that includes specific instructions dependent upon the mapping guide, origin information field template, and destination information field template;
provide the prompt that at least partially includes the mapping guide, origin information field template, and destination information field template to the large language model that requests the large language model to generate software code that, when executed, provides for a partial integration path for the communication of information from an origin to a destination; and
receive the software code from the large language model;
a complete integration path that, when performed by at least one computer processor, allows for the communication of information from the first application to the second application, the complete integration path having a first connection that links the first application to the origin set out in the software code, the software code that provides instructions for the communication of information from the origin to the destination, and a second connection that links the destination set out in the software code to the second application.

16. The system of claim 15, wherein the mapping guide, origin information field template, and the destination information field template are formulated by the integration generation software program.

17. The system of claim 16, wherein, after formulation, the mapping guide, origin information field template, and the destination information field template are stored in the first designated digital memory location.

18. The system of claim 15, wherein the origin information field template includes multiple information fields that are able to be communicated from the first application with each information field including at least one corresponding sample value even if that specific information field is not being communicated to the second application.

19. The system of claim 18, wherein the destination information field template includes multiple information fields that are able to be received by the second application with each information field including at least one corresponding sample value even if that specific information field is not being received by the second application from the first application.

20. The system of claim 15, wherein the integration generation software program is configured to generate the user portion of the prompt depending on the digital name of the mapping guide.
